(19) United States
(12) Patent Application Publication
(10) Pub. No.: US 2014/0329437 A1
(43) Pub. Date: Nov. 6, 2014

(54) A method and apparatus for treating a bees nest

(71) Applicant: Horacio Acevedo, Princeton, TX (US)

(72) Inventor: Horacio Acevedo, Princeton, TX (US)

(21) Appl. No.: 13/887,341

(22) Filed: May 5, 2013

(51) Int. Cl. A01K 51/00

(52) U.S. Cl. CPC A01K 51/00
USPC 449/1

(57) ABSTRACT

A method to remove bees from a bees nest includes the steps of placing a bee repellent to a target position near the bee nest, removing the bee repellent from the target position after a predetermined amount of time, removing honey from the bees nest and sealing the bees nest so that the bees cannot access the bee nest.

### FIELD OF THE INVENTION

The present invention relates generally to insect control and more particularly to a method for eliminating bees and their nest.

### BACKGROUND

Most carpenter bees, Xylocopa spp., are large and robust insects resembling bumble bees. They are usually about 1 inch long and colored a metallic blue-black with green or purplish reflections. They differ from bumble bees in that their abdomen is shiny with fringes of hairs on some segments. Males of some species are lighter colored, ranging into golden or buff hues. Female carpenter bees bore into sound wood or sometimes into decaying wood to make nests. Nests usually consist of tunnels ½ inch in diameter and 6 to 10 inches deep that are partitioned into several chambers, each containing an egg and a supply of food (pollen). The tunnel entrance has been noted to slope upward, commonly a near vertical opening in the side or bottom surface of a wooden member. Carpenter bees may use old tunnels for their nests, which they sometimes enlarge; several bees may use a common entry hole connecting to different tunnels. Over a period of time, tunnels may extend as far as 10 feet into wood timbers. Tunnels are vacated after the brood's larval and pupal stages complete their development. Development from egg to adult may take about 3 months. Carpenter bees overwinter as adults, often in old tunnels, and there is only one generation a year.

Carpenter bees cause damage to wooden structures by boring into timbers and siding to prepare nests. The nests weaken structural wood and leave unsightly holes and stains on building surfaces. Woodpeckers feeding on carpenter bee larvae multiply the damage by tearing open the nests. Sound, undecayed wood without paint or bark is usually selected for nests. Farm structures that feature exposed unpainted rafters are particularly susceptible to infestation. Since the bees do not eat the wood, lumber that is naturally insect resistant or treated to resist insects is susceptible to infestation. In testing and field observations, carpenter bees were most attracted to Juniperus virginiana wood of the Cupressaceae family, presumably since the aromatic insect-resistant nature of the wood repels parasites of the bees. Standing dead Juniperus virginiana trees are conspicuous as sites of carpenter bee colonies in the southeastern United States. Carpenter bees also frequently attack dead wood on trees or lumber from southern yellow pine, white pine, California redwood, cedar, Douglas fir, cypress, mimosa, mulberry, ash, and pecan trees. They avoid most harder woods. The presence of carpenter bees around buildings and wooden structures can be annoying or even frightening; however, males cannot sting and females rarely attack.

The related art has disclosed numerous forms of pesticides that are used to kill flying insects such as hornets, wasps, bees, and the like. Such pesticides are often contained in an aerosol can that is capable of spraying an intense stream of pesticide in excess of twenty feet, providing a sufficient trajectory to reach most carpenter bee holes. Many of these pesticides will knock down an airborne insect that contacts the spray. The carpenter bee is a highly agile flyer, and can avoid a jet stream of pesticide while flying. Carpenter bee holes are often times sprayed with a pesticide in an attempt to control their damage. Unfortunately, it is extremely difficult to spray the carpenter bee eggs with pesticide because the carpenter bee tunnels make a right angle turn from their point of entry. These difficulties make the use of pesticides ineffective, and result in unnecessary and ineffective application of pesticides, causing significant environmental damage.

U.S. Pat. No. 7,757,432 discloses a carpenter bee trap having a housing that contains a hole, an electrode in proximity to the hole, and a power source connected to the electrode. The hole is of a size similar to the size holes that carpenter bees normally make, thus attracting the carpenter bees to the hole. The carpenter bees will enter the hole, and make contact with an electrode. The electrode is energized through connection with a power source. In one embodiment, the power source includes a photovoltaic panel. Once the carpenter bee makes contact with the electrode, a high voltage discharge will take place through the body of the carpenter bee, thus killing the carpenter bee. The carpenter bee will then fall from the hole, and the trap will be ready for the next carpenter bee to enter.

U.S. Pat. No. 6,582,714 discloses an insect control article to control flying insects. The insect control article has a substrate that is impregnated with an active insect control ingredient that is available for passive evaporation. The active insect control ingredient is selected from the group consisting of transfluthrin, prallethrin, tefluthrin, esbiothrin, and combinations thereof. The method of the invention for controlling flying insects includes providing an insect control article having a substrate that is impregnated with an active insect control ingredient available for passive evaporation, wherein the active insect control ingredient is selected from the group consisting of transfluthrin, prallethrin, vaporthrin, teflurthrin, esbiothrin, DDVP, and combinations thereof. The insect control article is then placed in an environment with air movement in such a manner that the substrate of the insect control article is exposed to the air movement, and the active insect control ingredient impregnated within the substrate is allowed to evaporate passively into the air.

U.S. Pat. No. 6,766,611 discloses a plastic box with a hole to trap carpenter bees. The premise of such a trap is that the carpenter bees will enter the hole in the plastic box, and will be unable to find their way back out of the plastic box. For the few carpenter bees that are not physically able to locate the hole and exit the box, this leaves a live carpenter bee in the box that requires disposal.

U.S. Pat. No. 6,637,149 discloses a bee and wasp trap comprising a threaded cylindrical base unit with handles, a bait, a curved funnel shaped insert having internal lugs containing holes and configured to thread into the base unit, and a lid having tabs with pins, such that rotation of the lid engages the pins within the lug holes, and such that removal of the lid turns the trap on. The bee and wasp trap has particular utility in connection with efficient abatement of bees, yellow jackets, and other stinging insects around the exterior of residential homes and other outdoor locations.

U.S. Pat. No. 4,858,374 discloses a bee trap particularly suited for yellow jacket bees having a housing with an enclosed bottom which retains some attractant liquid. A snap fit lid is provided to enclose the upper end of the housing. One or more horizontally extending bee entrance tubes having one end joined to the housing where an aperture is provided for the entrance of bees. The bee entrance tube is of a particular length and configuration and is oriented with respect to the bottom and side surfaces of the housing to present extreme difficulties in enabling a bee to escape the device once inside.

U.S. patent application 20100269402 discloses a carpenter bee trap having at least one entrance hole, at least one plenum section connecting the at least one entrance hole to at least one receptacle adapter coupling, and least one removable receptacle attached to at least one receptacle adapter coupling, the at least one removable receptacle made of a material that admits ambient light to a greater extent than the material forming the plenum such that insects entering the trap follow a path of increasing intensity of ambient light that leads them to the receptacle. Various embodiments employ one or more preferred carpenter bee habitat features including an overhanging roof protecting the entrance hole from the weather, an entrance hole that slopes upward from horizontal, entrance holes surrounded by wood, and an opaque material forming the plenum regions such that the interior in the vicinity of the entrance holes is relatively dark. Various alternatives are possible for example to enhance trap performance in various situations or to make the traps aesthetically pleasing to a variety of tastes. In one embodiment, existing carpenter bee nests are treated with a disclosed insecticide gel. The insecticide gel consists of a thixotropic, injectable, non-hardening, non-volatile gel blended with a pyrethroid insecticide. A small amount of gel injected into existing nests kills all bees and larvae in the nests as well as any bees that enter the nest during the residual life of the application, in effect converting the bee nest into a trap. The combination of installed traps and treatment of existing nests with the insecticide gel has proven to be highly effective in treating and preventing carpenter bee infestation in structures.

U.S. patent application 20090126258 discloses an insect trap including a container adapted to be supported between a pair of racks in a bee hive, the trap cover having one or more apertures adapted to permit beetles to crawl into the trap. The cover can project beyond the edges of the container to support the trap between the racks or the trap can include attachment means to permit the trap to be removably attached at the hive entrance. The trap can contain oil to help prevent the beetle from escaping from the trap.

### SUMMARY

A method to remove bees from a bees nest includes the steps of placing a bee repellent to a target position near the bee nest, removing the bee repellent from the target position after a predetermined amount of time, removing honey from the bees nest and sealing the bees nest so that the bees cannot access the bee nest.

The bee repellent may be placed by a user.

The bee repellent may be removed by a user.

The honey may be removed by bees.

The bees from the nest may leave the nest in response to the bee repellent.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a target location for the beehive of the present invention;

FIG. 2 illustrates the method steps of the present invention.

### DETAILED DESCRIPTION

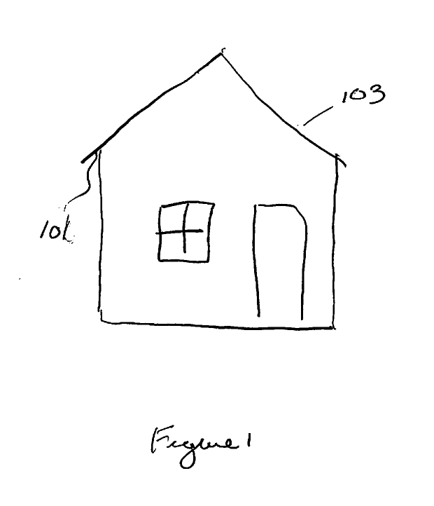

FIG. 1 illustrates a structure 103 which may be a home or business which may include a target location 101 which may be a position under the eaves of the structure 103 which may include a nest of bees to be removed.

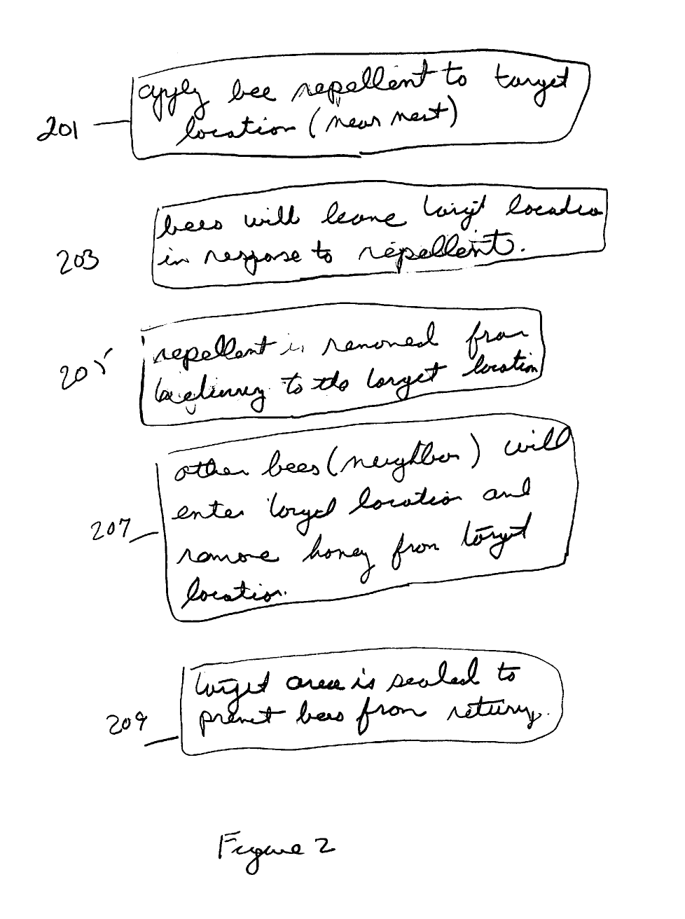

FIG. 2 illustrates the steps of the present invention to remove the resident bees from the target location 101.

In step 201, the user may apply a repellent which may be a bee repellent which may be an impregnated strip of material and may include DICHORVOS bee repellant which may be one of or in combination 2.2 Dichloro-Vinyl Dimethyl Phosphate. The bee repellent may be placed at the target location 101 or near the target location 101 in order to keep the resident bees from the nest of bees. The resident bees may be referred to as the bees which are inhabiting the nest of bees.

The resident bees may leave the target location 101 in response to the presence of the repellent in step 203. In addition, neighborhood bees may not enter the target location 101 as a result of the presence of the bee repellent. The neighborhood bees may be the same type of bees as the resident but are from a different nest.

After a predetermined period of time which may be several days or weeks, the user removes the repellent from the target location 101 in step 205.

The honey at the bee nest at the location 101 may be unprotected, and in step 207, other neighborhood bees such as predator bees may remove the honey from the bees nest at the target location 101. Without the honey, the resident bees will have no reason to return to the bees nest at the target location 101.

In step 209, the target area is sealed by the user to prevent bees from returning to the nest of the target area 101. Caulking and painting may be used to seal the target area 101.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A method to remove bees from a bees nest, comprising the steps of:
placing a bee repellent to a target position near the bee nest;
removing the bee repellent from the target position after a predetermined amount of time;
removing honey from the bees nest;
sealing the bees nest so that the bees cannot access the bee nest.

2) A method to remove bees from a bees nest as in claim 1, wherein the bee repellent is placed by a user.

3) A method to remove bees from a bees nest as in claim 1, wherein the be repellent is removed by a user.

4) A method to remove bees from a bees nest as in claim 1, wherein the honey is removed by bees.

5) A method to remove bees from a bees nest as in claim 5, wherein the bees from the nest leave the nest in response to the bee repellent.
